(19) United States
(12) Patent Application Publication
(10) Pub. No.: US 2002/0188362 A1
(43) Pub. Date: Dec. 12, 2002

(54) Digital recording microphone

(76) Inventor: Tung-Liang Li, Tainan (TW)

Correspondence Address: Alan D. Kamrath, Rider, Bennett, Egan & Arundel, LLP, Suite 2000, 333 South Seventh Street, Minneapolis, MO, 55402, US

(21) Appl. No.: 09/877,360

(22) Filed: Jun. 8, 2001

(51) Int. Cl. G06F 17/00

(52) U.S. Cl. 700/94

(57) ABSTRACT

A digital recording microphone has a hollow rod, a head disposed on the hollow rod, a connector disposed in a bottom of the hollow rod, a digital recorder disposed in the hollow rod, and a cover disposed on the hollow rod to cover the digital recorder. The hollow rod has a speaker, a line-in jack, an earphone jack, and a personal computer connecting jack. The digital recorder has a display, a pause button, a fast-selection button, a hold button, a clear-away button, a play button, a repeat button, a record button, a fast-forward button, a recording-mode button, a memory device, and a plurality of cells.

### BACKGROUND OF THE INVENTION

The present invention relates to a digital recording microphone. More particularly, the present invention relates to a digital recording microphone which has a digital recorder.

A conventional microphone cannot convert a voice to a digital file directly. Therefore, the voice should be recorded and converted to the digital file by different machines.

### SUMMARY OF THE INVENTION

An object of the present invention is to provide a digital recording microphone which has a digital recorder to convert a voice into a digital file directly.

Another object of the present invention is to provide a digital recording microphone which has a digital recorder to convert a voice into a word file directly.

In accordance with a first preferred embodiment of the present invention, a digital recording microphone comprises a hollow rod, a head disposed on the hollow rod, a connector disposed in a bottom of the hollow rod, a digital recorder disposed in the hollow rod, and a cover disposed on the hollow rod to cover the digital recorder. The hollow rod has a speaker, a line-in jack, an earphone jack, and a personal computer connecting jack. The digital recorder has a display, a pause button, a fast-selection button, a hold button, a clear-away button, a play button, a repeat button, a record button, a fast-forward button, a recording-mode button, a memory device, and a plurality of cells.

In accordance with a second preferred embodiment of the present invention, a digital recording microphone comprises a rod, a head disposed on the rod, a socket disposed in a bottom of the rod, and a digital recorder disposed on the bottom of the rod. The digital recorder has a display, a pause button, a fast-selection button, a hold button, a clear-away button, a play button, a repeat button, a record button, a fast-forward button, a recording-mode button, a memory device, a plurality of cells, a lower connector, and an upper connector. The upper connector engages with the socket. A plug engages with the lower connector.

### BRIEF DESCRIPTION OF THE DRAWINGS

FIG. 1 is a perspective view of a digital recording microphone of a first preferred embodiment in accordance with the present invention; and

FIG. 2 is a perspective exploded view of a digital recording microphone of a second preferred embodiment in accordance with the present invention.

### DETAILED DESCRIPTION OF THE INVENTION

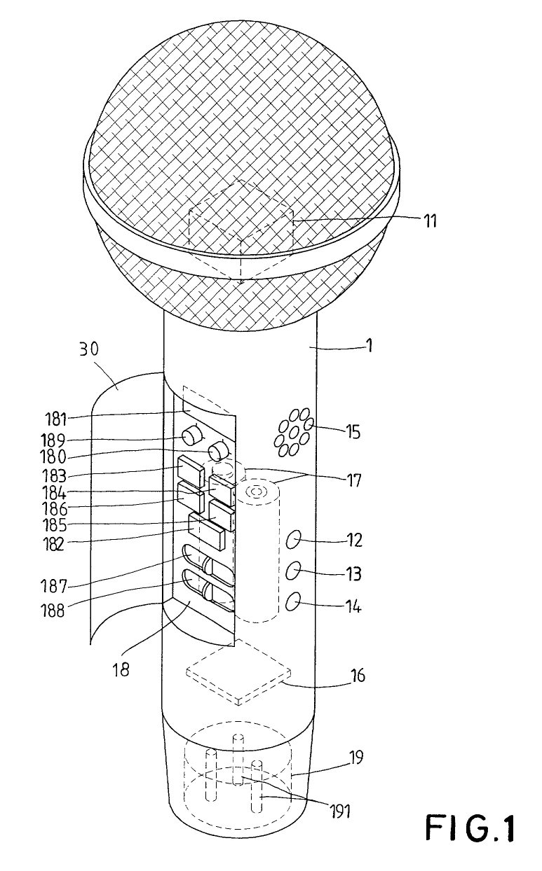

Referring to FIG. 1, a first digital recording microphone comprises a hollow rod 1, a head 11 disposed on the hollow rod 1, a connector 19 disposed in a bottom of the hollow rod 1, a digital recorder 18 disposed in the hollow rod 1, and a cover 30 disposed on the hollow rod 1 to cover the digital recorder 18.

The connector 19 has a plurality of posts 191.

The hollow rod 1 has a speaker 15, a line-in jack 12, an earphone jack 13, and a personal computer connecting jack 14.

The digital recorder 18 has a display 181, a hold button 189, a fast-selection button 180, a pause button 183, a clear-away button 184, a play button 186, a repeat button 185, a record button 182, a fast-forward button 187, a recording-mode button 188, a memory device 16, and a plurality of cells 17.

The display 181 is a liquid crystal display.

The record button 182 starts a recording and stops the recording.

The pause button 183 pauses the recording.

The clear-away button 184 clears away a single recording or all the recordings.

The repeat button 185 plays the recording again and again.

The play button 186 plays the recording once.

The fast-forward button 187 has a fast-forward function.

The recording-mode button 188 selects a standard mode, a background voice eliminating mode, or voice recording mode.

The fast-selection button 180 stores the recordings in different sections so that a search of a particular recording is fast.

It is an option to provide a computer connecting interface and a voice recognition unit in the digital recorder 18 in order to convert a voice into a word file directly.

The digital recorder 18 transforms a voice into a digital file having a MP3 (motion pictures experts group standard 3) format, an ADPCM (adaptive differential pulse code modulation) format, a CELP (code excited linear predition) format, or a GSM (anglicizend global standard for mobile communications) format.

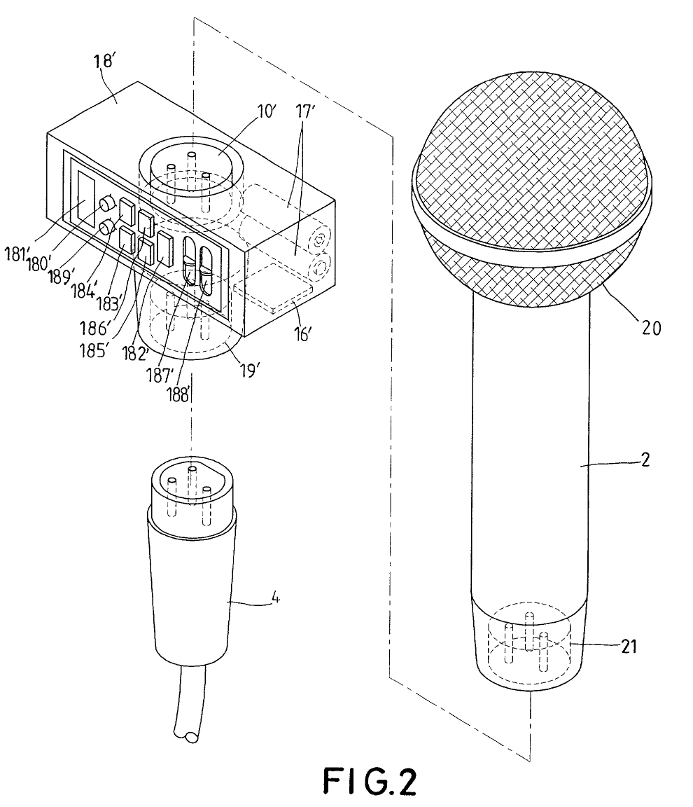

Referring to FIG. 2, a second digital recording microphone comprises a rod 2, a head 20 disposed on the rod 2, a socket 21 disposed in a bottom of the rod 2, and a digital recorder 18′ disposed on the bottom of the rod 2.

The digital recorder 18′ has a display 181′, a hold button 189′, a fast-selection button 180′, a pause button 183′, a clear-away button 184′, a play button 186′, a repeat button 185′, a record button 182′, a fast-forward button 187′, a recording-mode button 188′, a memory device 16′, a plurality of cells 17′, a lower connector 19′, and an upper connector 10′.

The upper connector 10′ engages with the socket 21.

A plug 4 engages with the lower connector 19′.

The display 181′ is a liquid crystal display.

The record button 182′ starts a recording and stops the recording.

The pause button 183′ pauses the recording.

The clear-away button 184′ clears away a single recording or all the recordings.

The repeat button 185′ plays the recording again and again.

The play button 186′ plays the recording once.

The fast-forward button 187′ has a fast-forward function.

The recording-mode button 188′ selects a standard mode, a background voice eliminating mode, or voice recording mode.

The fast-selection button 180′ stores the recordings in different sections so that a search of a particular recording is fast.

It is an option to provide a computer connecting interface and a voice recognition unit in the digital recorder 18′ in order to convert a voice into a word file directly.

The digital recorder 18′ transforms a voice into a digital file having a MP3 (motion pictures experts group standard 3) format, an ADPCM (adaptive differential pulse code modulation) format, a CELP (code excited linear predition) format, or a GSM (anglicizend global standard for mobile communications) format.

The invention is not limited to the above embodiment but various modification thereof may be made. Further, various changes in form and detail may be made without departing from the scope of the invention.

I claim:

1. A digital recording microphone comprises:
a hollow rod, a head disposed on the hollow rod, a connector disposed in a bottom of the hollow rod, a digital recorder disposed in the hollow rod, and a cover disposed on the hollow rod to cover the digital recorder,
the hollow rod having a speaker, a line-in jack, an earphone jack, and a personal computer connecting jack,
the digital recorder having a display, a pause button, a fast-selection button, a hold button, a play button, a clear-away button, a repeat button, a record button, a fast-forward button, a recording-mode button, a memory device, and a plurality of cells.

2. A digital recording microphone comprises:
a rod, a head disposed on the rod, a socket disposed in a bottom of the rod, and a digital recorder disposed on the bottom of the rod,
the digital recorder having a display, a pause button, a fast-selection button, a hold button, a clear-away button, a play button, a repeat button, a record button, a fast-forward button, a recording-mode button, a memory device, a plurality of cells, a lower connector, and an upper connector,
the upper connector engaging with the socket, and
a plug engaging with the lower connector.
